(19) United States
(12) Patent Application Publication
(10) Pub. No.: US 2007/0282147 A1
(43) Pub. Date: Dec. 6, 2007

(54) Magnesium Chloride-Based Adducts And Catalyst Components Obtained Therefrom

(75) Inventors: Yuri Gulevich, Ferrara (IT); Isabella Comurati, Ferrara (IT); Antonio Cristofori, Occhiobello (IT); Tiziano Dall'Occo, Ferrara (IT); Giampiero Morini, Padova (IT); Fabrizio Piemontesi, Ferrara (IT); Gianni Vitale, Ferrara (IT)

Correspondence Address: BASELL USA INC., INTELLECTUAL PROPERTY, 912 APPLETON ROAD, ELKTON, MD, 21921, US

(73) Assignee: Basell Poliolefine Italia s.r.l., Milan (IT)

(21) Appl. No.: 10/594,780

(22) PCT Filed: Mar. 3, 2005
(86) PCT No.: PCT/EP05/02371

§ 371 Date: Sep. 29, 2006

Related U.S. Application Data
(60) Provisional application No. 60/557,813, filed on Mar. 30, 2004.

(30) Foreign Application Priority Data
Mar. 29, 2004 (EP) 04101281.6

(51) Int. Cl. C08F 110/06; C07F 3/02; C08F 4/651

(52) U.S. Cl. 585/502; 502/154; 549/429; 568/300; 568/579

(57) ABSTRACT

Lewis base adducts comprising MgClₙ(OR)₂₋ₙ, and an aprotic Lewis base that are in molar ratios to each other defined by the formula MgClₙ(OR)₂₋ₙLBₚ in which n is from 0.1 to 1.9, p is higher than 0.4, and R is a C1-C15 hydrocarbon group. The adducts of the present invention are particularly useful as precursors of Ziegler-Natta catalyst components for the polymerization of olefins.

The present invention relates to Lewis base adducts comprising compounds of a specified formula and including at least a magnesium compound and a Lewis base in specific amounts. The adducts of the present invention are particularly useful as precursors of Ziegler-Natta catalyst components for the polymerization of olefins.

The modern ZN catalysts including titanium compounds supported on magnesium halides are well known in the art. Catalysts of this type are described in the U.S. Pat. No. 4,298,718. Said catalysts comprise titanium tetrahalides supported on halides of magnesium. Although the catalysts have high activity in the polymerization of alpha olefins like propylene, they are not very stereospecific. Improvements to stereospecificity have been obtained by adding electron-donor compounds to the solid catalyst component.

Substantial improvements were obtained by using, in addition to the electron-donor present in the solid component, an electron-donor (external) added either to the aluminum alkyl co-catalyst component or the polymerization reactor.

The catalysts modified in this manner, although being highly stereospecific (the obtained polymer is about 94-95% insoluble in xylene), still did not show sufficiently high levels of activity.

Significant improvements in both activity and stereospecificity were obtained by preparing the solid catalytic component according to the technique described in U.S. Pat. No. 4,226,741. High level performance in catalyst activity as well as stereospecificity has been obtained with the catalysts described in the European patent No. 045977. Said catalysts comprise as a solid catalysts component, a magnesium halide on which is supported a titanium halide, preferably TiCl₄, and an electron-donor compound, selected from specific classes of carboxylic acid esters, and, as co-catalyst component, a system formed of an Al-trialkyl compound and a silicon compound containing at least one Si—OR bond (R hydrocarbon radical). Nevertheless, research activities have been running with the purpose of modifying and/or improving the performance of the mentioned catalysts.

The European patent EP 361494 and EP 728769 describe very active solid catalyst components for the polymerization of olefins comprising, as an internal electron-donor compound, a 1,3-diether characterized by a specific structure and/or by specific reactivity characteristics toward the anhydrous magnesium chloride and TiCl₄.

The catalysts obtained from the reaction of said catalyst components with an Al-alkyl compound exhibit a so high activity and stereospecificity in the polymerization of olefins, that the use of an external electron-donor can be avoided.

The catalyst activity is particularly high when the catalyst is obtained starting from precursors comprising adducts of formula MgCl₂(ROH)ₙ where R is a C1-C10 alkyl group preferably, ethyl, and n is from 2 to 6. When a precursor of this type is reacted with the titanium compound, usually TiCl₄, a large amount of hydrochloric acid evolves, which must be neutralized and removed. Moreover, it has to be considered that the yield of such a support is not particularly high. For example the amount of final catalyst obtained generally contains MgCl₂ in an amount which is only about 40% by weight of the amount of the starting support considering an n value of about 3. The percentage is even lower for higher n values.

Precursors that do not generate hydrogen chloride and that yield higher proportions of final catalysts are for example those disclosed in U.S. Pat. No. 4,315,835 that are of general formula MgXₙ(OR)₂₋ₙ. In addition, these precursors are able to generate a final catalyst characterized by a narrow particle size distribution even when the catalyst particles have small average diameter such as below 50 μm. One problem associated with this kind of precursor however was the low polymerization activity expressed in terms of amount of polymer per g of catalyst component. The applicant has now found novel precursors that upon reaction with Ti compounds generate in high yields catalyst components with high polymerization activity and that during said reaction do not substantially generate hydrogen chloride.

The said catalyst precursors comprise Lewis base adduct comprising a compound of formula MgClₙ(OR)₂₋ₙ, and an aprotic Lewis base (LB) that are in molar ratios to each other defined by the formula MgClₙ(OR)₂₋ₙLBₚ in which n is from 0.1 to 1.9, p is higher than 0.4, and R is a C1-C15 hydrocarbon group.

Preferably, p is higher than 0.45 and more preferably it ranges from 0.5 to 3 and especially from 0.5 to 2.

In a particular aspect of the present invention, n ranges from 0.4 to 1.6 and preferably from 0.7 to 1.5.

The aprotic Lewis base is preferably selected from ethers, esters, ketones, silanes, amines, nitrites and amides. Preferably, it is selected from ethers or esters.

Preferred ethers are the C2-C20 aliphatic ethers and in particular the cyclic ethers preferably having 3-5 carbon atoms such as tetrahydrofurane (THF), dioxane.

Preferred esters are the alkyl esters of C1-C20 aliphatic carboxylic acids and in particular C1-C8 alkyl esters of aliphatic mono carboxylic acids such as ethyl acetate, methyl formate, ethyl formate, methyl acetate, propyl acetate, isopropyl acetate, n-butyl acetate, isobutyl acetate.

Preferred alkoxysilanes are those of formula R¹ₐR²_{b}Si(OR³)_{c}, where a and b are integer from 0 to 2, c is an integer from 1 to 4 and the sum (a+b+c) is 4; R¹, R², and R³, are alkyl, cycloalkyl or aryl radicals with 1-18 carbon atoms optionally containing heteroatoms. Particularly preferred are the silicon compounds in which a is 0 or 1, c is 2 or 3, R² is an alkyl or cycloalkyl group, optionally containing heteroatoms, and R³ is methyl. Examples of such preferred silicon compounds are methyltrimethoxysilane, dimethyldimethoxysilane, trimethylmethoxysilane and t-butyltrimethoxysilane.

Preferred ketones are those of formula R⁴COR⁴, in which the R⁴ groups are, independently, a C1-C20 hydrocarbon group. Particularly preferred are the ketones in which at least one of R⁴ is a C1-C10 alkyl group.

Preferred amines are those of formula NR⁵₃ in which the R⁵ groups are, independently, a C1-C20 hydrocarbon group. Preferably, R⁵ is a C1-C10 alkyl group. Specific examples are triethylamine, triisopropylamine and tri-n-butylamine.

Preferred amides are those of formula R⁶CONR⁷₂, in which R⁶ is hydrogen or a C1-C20 hydrocarbon group and R⁷ are, independently, a C1-C20 hydrocarbon group. Specific examples are N,N-dimethylformamide and N,N-dimethylacetamide.

Preferred nitriles are those of formula R⁸CN where R⁸ has the same meaning as R⁴. A specific example is acetonitrile. Preferably, R⁸ is a C1-C10 alkyl group. Specific examples are methyl, ethyl, isopropyl, and butyl.

The precursors of the present invention can be prepared according to several methods. One of the preferred methods comprises causing the formation of MgClₙ(OR)₂, compounds to take place in the presence of the LB compound. The carriers obtained by this method in fact show better properties over those obtained by contacting the already pre-formed MgClₙ(OR)₂₋ₙ species with the LB compound.

The MgClₙ(OR)₂₋ₙ compounds can be generated by exchange reaction between organometallic compounds of formula ClₘMgR₂₋ₘ, where m is from 0.1 to 1.9, and R is a hydrocarbon group, with an appropriate —OR source. The OR sources are for example ROH alcohols or, preferably, a silicon compound of formula (RO)ᵣSiR₄₋ᵣ where r is from 1 to 4 and R has the meaning given above, silicon tetra-ethoxide being preferred. In turn, as generally known in the art, organometallic compounds of formula ClₘMgR₂₋ₘ can be obtained by reaction between Mg metal and an organic chloride RCl, in which R is as defined above, optionally in the presence of suitable promoters. Preferably, the formation of ClₘMgR₂₋ₘ and the further exchange with the OR source takes place in one single step. In this case it is particularly preferred that the LB compound is present from the beginning of the reaction that leads to the formation of ClₘMgR₂₋ₘ species. The use of the preferred ethers mentioned above is particularly suitable in carrying out this method. The reaction can be carried out in inert medium such as hydrocarbon that is liquid at room temperature. Usually, upon a substantial amount of exchange with the OR source occurred, the compounds of formula MgClₙ(OR)₂₋ₙLBₚ precipitate and can be easily isolated.

According to another method, compounds of formula MgClₙ(OR)₂₋ₙLBₚ can be prepared causing Mg(OR)₂ compounds being chlorinated, in the presence of LB compounds, by R⁹Cl compounds where R⁹ is H or R.

According to a further method, the compounds of formula MgClₙ(OR)₂₋ₙLBₚ can be prepared by causing mixtures of MgCl₂ and Mg(OR)₂ to react in the presence of the LB compound. When esters are used as the LB compound, ethyl acetate is particularly preferred. When ethers are used as LB compound, the preferred ethers mentioned above, and in particular THF, are particularly suitable in carrying out this method. Although an inert solvent can be used for bringing into contact the starting compounds this is not mandatory. It has been found advantageous to use amount of LB such that a clean solution of reaction product is obtained. Reaction temperature has not been found critical although temperature causing the decomposition of any of the reactants or products should be avoided. From this solution the compounds of formula MgClₙ(OR)₂₋ₙLBₚ can be isolated with known techniques such as crystallization, precipitation with non-solvents, etc.

As mentioned above, these precursors can be advantageously used, either solid or in solution, in the preparation of catalyst components for the polymerization of olefins. The said catalyst components can be obtained by contacting the precursors of the invention with compounds of transition metals belonging to one of the groups 4 to 6 of the Periodic Table of Elements (new notation). Among transition metal compounds particularly preferred are titanium compounds of formula Ti(OR)ₙX_{y-n} in which n is comprised between 0 and y; y is the valence of titanium; X is halogen and R is an alkyl radical having 1-10 carbon atoms or a COR group. Among them, particularly preferred are titanium compounds having at least one Ti-halogen bond such as titanium tetrahalides or halogenalcoholates. Preferred specific titanium compounds are TiCl₃, TiCl₄, Ti(OBu)₄, Ti(OBu)Cl₃, Ti(OBu)₂Cl₂, Ti(OBu)₃Cl. Preferably the contact is carried out by suspending the precursor in cold TiCl₄ (generally 0° C.); then the so obtained mixture is heated up to 80-130° C. and kept at this temperature for 0.5-2 hours. After that the excess of TiCl₄ is removed and the solid component is recovered. The treatment with TiCl₄ can be carried out one or more times. As mentioned above, also a steromodulating electron donor compound can be added to the solid catalyst component in order to make it stereospecific. The introduction of the electron donor can be done simultaneously with the reaction between transition metal compound and the adduct. As a result of this contact the electron donor compound normally remains deposited on the catalyst component. Said electron donor compound can be same as, or different from, the LB compound mentioned above and is generally selected from esters, ethers, amines, and ketones. In particular, as mentioned above, excellent results have been obtained with the use of 1,3-diethers of formula (I) 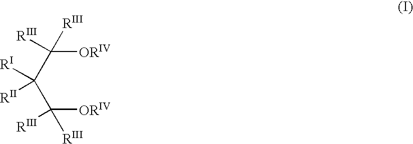
where R^{I} and R^{II} are the same or different and are hydrogen or linear or branched C₁-C₁₈ hydrocarbon groups which can also form one or more cyclic structures; R^{III} groups, equal or different from each other, are hydrogen or C₁-C₁₈ hydrocarbon groups; R^{IV} groups equal or different from each other, have the same meaning of R^{III} except that they cannot be hydrogen; each of R^{I} to R^{IV} groups can contain heteroatoms selected from halogens, N, O, S and Si.

Preferably, R^{IV} is a 1-6 carbon atom alkyl radical and more particularly a methyl while the R^{III} radicals are preferably hydrogen. Moreover, when R^{I} is methyl, ethyl, propyl, or isopropyl, R^{II} can be ethyl, propyl, isopropyl, butyl, isobutyl, tert-butyl, isopentyl, 2-ethylhexyl, cyclopentyl, cyclohexyl, methylcyclohexyl, phenyl or benzyl; when R^{I} is hydrogen, R^{II} can be ethyl, butyl, sec-butyl, tert-butyl, 2-ethylhexyl, cyclohexylethyl, diphenylmethyl, p-chlorophenyl, 1-naphthyl, 1-decahydronaphthyl; R^{I} and R^{II} can also be the same and can be ethyl, propyl, isopropyl, butyl, isobutyl, tert-butyl, neopentyl, phenyl, benzyl, cyclohexyl, cyclopentyl.

Specific examples of ethers that can be advantageously used include: 2-(2-ethylhexyl)-1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2-(2-cyclohexylethyl)-1,3-dimethoxypropane, 2-(p-chlorophenyl)-1,3-dimethoxypropane, 2-(diphenylmethyl)-1,3-dimethoxypropane, 2-(1-naphthyl)-1,3-dimethoxypropane, 2-(p-fluorophenyl)-1,3-dimethoxypropane, 2-(1-decahydronaphthyl)-1,3-dimethoxypropane, 2-(p-tert-butylphenyl)-1,3-dimethoxypropane, 2,2-dicyclohexyl-1,3-dimethoxypropane, 2,2-diethyl-1,3-dimethoxypropane, 2,2-dipropyl-1,3-dimethoxypropane, 2,2-dibutyl-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2-methyl-2-phenyl-1,3-dimethoxypropane, 2-methyl-2-cyclohexyl-1,3-dimethoxypropane, 2-methyl-2-methylcyclohexyl-1,3-dimethoxypropane, 2,2-bis(p-chlorophenyl)-1,3-dimethoxypropane, 2,2-bis(2-phenylethyl)-1,3-dimethoxypropane, 2,2-bis(2-cyclohexylethyl)-1,3-dimethoxypropane, 2-methyl-2-isobutyl-1,3-dimethoxypropane, 2-methyl-2-(2-ethylhexyl)-1,3-dimethoxypropane, 2,2-bis(2-ethylhexyl)-1,3-dimethoxypropane, 2,2-bis(p-methylphenyl)-1,3-dimethoxypropane, 2-methyl-2-isopropyl-1,3-dimethoxypropane, 2,2-diisobutyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 2-isobutyl-2-isopropyl-1,3-dimetoxypropane, 2,2-di-sec-butyl-1,3-dimetoxypropane, 2,2-di-tert-butyl-1,3-dimethoxypropane, 2,2-dineopentyl-1,3-dimethoxypropane, 2-isopropyl-2-isopentyl-1,3-dimethoxypropane, 2-phenyl-2-benzyl-1,3-dimetoxypropane, 2-cyclohexyl-2-cyclohexylmethyl-1,3-dimethoxypropane.
Furthermore, particularly preferred are the 1,3-diethers of formula (II) 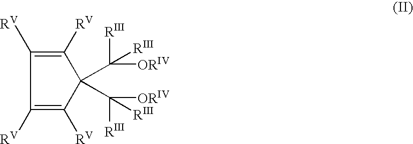
where the radicals R^{IV} have the same meaning explained above and the radicals R^{III} and R^{V} radicals, equal or different to each other, are selected from the group consisting of hydrogen; halogens, preferably Cl and F; C₁-C₂₀ alkyl radicals, linear or branched; C₃-C₂₀ cycloalkyl, C₆-C₂₀ aryl, C₇-C₂₀ alkaryl and C₇-C₂₀ aralkyl radicals and two or more of the R^{V} radicals can be bonded to each other to form condensed cyclic structures, saturated or unsaturated, optionally substituted with R^{VI} radicals selected from the group consisting of halogens, preferably Cl and F; C₁-C₂₀ alkyl radicals, linear or branched; C₃-C₂₀ cycloalkyl, C₆-C₂₀ aryl, C₇-C₂₀ alkaryl and C₇-C₂₀ aralkyl radicals; said radicals R^{V} and R^{VI} optionally containing one or more heteroatoms as substitutes for carbon or hydrogen atoms, or both. Preferably, in the 1,3-diethers of formulae (I) and (II) all the R^{III} radicals are hydrogen, and all the R^{IV} radicals are methyl. Moreover, are particularly preferred the 1,3-diethers of formula (II) in which two or more of the R^{V} radicals are bonded to each other to form one or more condensed cyclic structures, preferably benzenic, optionally substituted by R^{VI} radicals. Especially preferred are the compounds of formula (III): 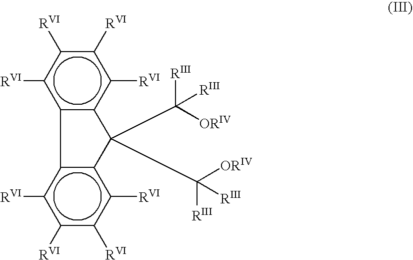
where the R^{VI} radicals equal or different are hydrogen; halogens, preferably Cl and F; C₁-C₂₀ alkyl radicals, linear or branched; C₃-C₂₀ cycloalkyl, C₆-C₂₀ aryl, C₇-C₂₀ alkylaryl and C₇-C₂₀ aralkyl radicals, optionally containing one or more heteroatoms selected from the group consisting of N, O, S, P, Si and halogens, in particular Cl and F, as substitutes for carbon or hydrogen atoms, or both; the radicals R^{III} and R^{IV} are as defined above for formula (II). Specific examples of compounds comprised in formulae (II) and (III) are: 1,1-bis(methoxymethyl)-cyclopentadiene; 1,1-bis(methoxymethyl)-2,3,4,5-tetramethylcyclopentadiene; 1,1-bis(methoxymethyl)-2,3,4,5-tetraphenylcyclopentadiene; 1,1-bis(methoxymethyl)-2,3,4,5-tetrafluorocyclopentadiene; 1,1-bis(methoxymethyl)-3,4-dicyclopentylcyclopentadiene; 1,1-bis(methoxymethyl)-indene; 1,1-bis(methoxymethyl)-2,3-dimethylindene; 1,1-bis(methoxymethyl)-4,5,6,7-tetrahydroindene; 1,1-bis(methoxymethyl)-2,3,6,7-tetrafluoroindene; 1,1-bis(methoxymethyl)-4,7-dimethylindene; 1,1-bis(methoxymethyl)-3,6-dimethylindene; 1,1-bis(methoxymethyl)-4-phenylindene; 1,1-bis(methoxymethyl)-4-phenyl-2-methylindene; 1,1-bis(methoxymethyl)-4-cyclohexylindene; 1,1-bis(methoxymethyl)-7-(3,3,3-trifluoropropyl)indene; 1,1-bis(methoxymethyl)-7-trimethylsilylindene; 1,1-bis(methoxymethyl)-7-trifluoromethylindene; 1,1-bis(methoxymethyl)-4,7-dimethyl-4,5,6,7-tetrahydroindene; 1,1-bis(methoxymethyl)-7-methylindene; 1,1-bis(methoxymethyl)-7-cyclopenthylindene; 1,1-bis(methoxymethyl)-7-isopropylindene; 1,1-bis(methoxymethyl)-7-cyclohexylindene; 1,1-bis(methoxymethyl)-7-tert-butylindene; 1,1-bis(methoxymethyl)-7-tert-butyl-2-methylindene; 1,1-bis(methoxymethyl)-7-phenylindene; 1,1-bis(methoxymethyl)-2-phenylindene; 1,1-bis(methoxymethyl)-1H-benz[e]indene; 1,1-bis(methoxymethyl)-1H-2-methylbenz[e]indene; 9,9-bis(methoxymethyl)-fluorene; 9,9-bis(methoxymethyl)-2,3,6,7-tetramethylfluorene; 9,9-bis(methoxymethyl)-2,3,4,5,6,7-hexafluorofluorene; 9,9-bis(methoxymethyl)-2,3-benzofluorene; 9,9-bis(methoxymethyl)-2,3,6,7-dibenzofluorene; 9,9-bis(methoxymethyl)-2,7-diisopropylfluorene; 9,9-bis(methoxymethyl)-1,8-dichlorofluorene; 9,9-bis(methoxymethyl)-2,7-dicyclopentylfluorene; 9,9-bis(methoxymethyl)-1,8-difluorofluorene; 9,9-bis(methoxymethyl)-1,2,3,4-tetrahydrofluorene; 9,9-bis(methoxymethyl)-1,2,3,4,5,6,7,8-octahydrofluorene; 9,9-bis(methoxymethyl)-4-tert-butylfluorene.

The catalyst components obtained by using these diethers in fact have improved properties, in terms of polymerization activity and stereospecificity, over those obtained by contacting the titanium compound and the 1,3-diether with precursors of the prior art such as those described in U.S. Pat. No. 4,315,835.

Suitable electron donors are also the alkyl and aryl esters of mono- or poly-carboxylic acids, preferably for example esters of benzoic, phthalic, malonic, glutaric and succinic acids. Specific examples of such esters are di-n-butyl phthalate, diisobutyl phthalate, di-n-octyl phthalate, diethyl 2,3-diisopropylsuccinate, diethyl 2,3-dicyclohexylsuccinate, ethyl benzoate and ethyl p-ethoxybenzoate.

The electron donor compound used in the preparation of the catalyst generally ranges, in molar ratios with respect to the magnesium, from 1:2 to 1:20.

The solid catalyst components according to the present invention may show a surface area (by B.E.T. method) generally between 10 and 500 m²/g and preferably between 20 and 350 m²/g, and a total porosity (by B.E.T. method) higher than 0.1 cm³/g preferably between 0.2 and 0.6 cm³/g.

The catalyst components of the invention form catalysts for the polymerization of alpha-olefins CH₂═CHR, wherein R is hydrogen or a hydrocarbon radical having 1-12 carbon atoms, by reaction or contact with organo-Al compounds in particular Al-alkyl compounds. The alkyl-Al compound is preferably chosen among the trialkyl aluminum compounds such as for example triethylaluminum, triisobutylaluminum, tri-n-butylaluminum, tri-n-hexylaluminum, tri-n-octylaluminum. It is also possible to use alkylaluminum halides, alkylaluminum hydrides or alkylaluminum sesquichlorides such as AlEt₂Cl and Al₂Et₃Cl₃ optionally in mixture with said trialkylaluminum compounds.

The Al/Ti ratio is higher than 1 and is generally comprised between 20 and 800.

In the case of the stereoregular polymerization of α-olefins, such as for example propylene and 1-butene, an electron donor compound (external donor) which can be the same or different from the compound used as internal donor can be used in the preparation of the catalysts disclosed above. In case the internal donor is an ester of a polycarboxylic acid, in particular a phthalate, the external donor is preferably selected from the silane compounds containing at least a Si—OR link, having the formula Rₐ¹R_{b}²Si(OR³)_{c}, where a and b are integer from 0 to 2, c is an integer from 1 to 3 and the sum (a+b+c) is 4; R¹, R², and R³, are alkyl, cycloalkyl or aryl radicals with 1-18 carbon atoms. Particularly preferred are the silicon compounds in which a is 1, b is 1, c is 2, at least one of R¹ and R² is selected from branched alkyl, cycloalkyl or aryl groups with 3-10 carbon atoms and R³ is a C₁-C₁₀ alkyl group, in particular methyl. Examples of such preferred silicon compounds are methylcyclohexyldimethoxysilane, diphenyldimethoxysilane, methyl-t-butyldimethoxysilane, and dicyclopentyldimethoxysilane. Moreover, are also preferred the silicon compounds in which a is 0, c is 3, R² is a branched alkyl or cycloalkyl group and R³ is methyl. Examples of such preferred silicon compounds are cyclohexyltrimethoxysilane, t-butyltrimethoxysilane and thexyltrimethoxysilane.

Also the 1,3-diethers having the previously described formula can be used as external donor. However, in the case 1,3-diethers are used as internal donors, the use of an external donor could be avoided, as the stereospecificity of the catalyst is already sufficiently high for polymers to be used in various applications.

As previously indicated, the components of the invention and catalysts obtained therefrom find applications in the processes for the (co)polymerization of olefins of formula CH₂═CHR in which R is hydrogen or a hydrocarbon radical having 1-12 carbon atoms.

The catalysts of the invention can be used in any of the olefin polymerization processes known in the art. They can be used for example in slurry polymerization using as diluent an inert hydrocarbon solvent or bulk polymerization using the liquid monomer (for example propylene) as a reaction medium. Moreover, they can also be used in the polymerization process carried out in gas-phase operating in one or more fluidized or mechanically agitated bed reactors.

The polymerization is generally carried out at temperature of from 20 to 120° C., preferably of from 40 to 80° C. When the polymerization is carried out in gas-phase the operating pressure is generally between 0.1 and 10 MPa, preferably between 1 and 5 MPa. In the bulk polymerization the operating pressure is generally between 1 and 6 MPa preferably between 1.5 and 4 MPa.

The catalysts of the invention are very useful for preparing a broad range of polyolefin products. Specific examples of the olefinic polymers which can be prepared are: high density ethylene polymers (HDPE, having a density higher than 0.940 g/cc), comprising ethylene homopolymers and copolymers of ethylene with alpha-olefins having 3-12 carbon atoms; linear low density polyethylenes (LLDPE, having a density lower than 0.940 g/cc) and very low density and ultra low density (VLDPE and ULDPE, having a density lower than 0.920 g/cc, to 0.880 g/cc) consisting of copolymers of ethylene with one or more alpha-olefins having from 3 to 12 carbon atoms, having a mole content of units derived from the ethylene higher than 80%; isotactic polypropylenes and crystalline copolymers of propylene and ethylene and/or other alpha-olefins having a content of units derived from propylene higher than 85% by weight; copolymers of propylene and 1-butene having a content of units derived from 1-butene comprised between 1 and 40% by weight; heterophasic copolymers comprising a crystalline polypropylene matrix and an amorphous phase comprising copolymers of propylene with ethylene and or other alpha-olefins.

The following examples are given to illustrate and not to limit the invention itself.

Characterization

Determination of X.I.

2.50 g of polymer were dissolved in 250 ml of o-xylene under stirring at 135° C. for 30 minutes, then the solution was cooled to 25° C. and after 30 minutes the insoluble polymer was filtered off. The resulting solution was evaporated in nitrogen flow and the residue was dried and weighed to determine the percentage of soluble polymer and then, by difference, the xylene insoluble fraction (%).

Particle Size Distribution (Span)

According to the present invention the particle size distribution is calculated with the formula

$$\frac{P 90 - P 10}{P 50}$$

where, in a particle size distribution curve, P90 is the value of the diameter such that 90% of the total particles have a diameter lower than that value; P10 is the value of the diameter such that 10% of the total particles have a diameter lower than that value and P50 is the value of the diameter such that 50% of the total particles have a diameter lower than that value.
Determination of Polydispersity Index

This property is strictly connected with the molecular weight distribution of the polymer under examination. In particular it is inversely proportional to the creep resistance of the polymer in the molten state. Said resistance called modulus separation at low modulus value (500 Pa), was determined at a temperature of 200° C. by using a parallel plates rheometer model RMS-800 marketed by RHEOMETRICS (USA), operating at an oscillation frequency which increases from 0.1 rad/sec to 100 rad/sec. From the crossover modulus one can derive the P.I. by way of the equation:
P.I.=10⁵/Gc
in which Gc is the crossover modulus which is defined as the value (expressed in Pa) at which G′=G″ wherein G′ is the storage modulus and G″ is the loss modulus.

Melt Index: measured at 190° C. according to ASTM D-1238 condition “L”

Intrinsic viscosity: determined in tetrahydronaphthalene at 135° C.

### EXAMPLES

General Procedure for the Preparation of a Diether Based Catalyst (Procedure A)

Into a 800 mL four-neck glass reactor, equipped with a mechanical stirrer, a reflux condenser and a thermometer and purged with nitrogen, 300 mL of TiCl₄ were introduced and cooled to 0° C. While stirring, 12.0 g of the precursor (adduct prepared as described in one of the following examples) were added. The temperature was raised to 40° C. in 0.5 h and after that 9,9-bis(methoxymethyl)fluorene in the amount corresponding to 0.167 moles per mole of Mg present in the precursor was added to the suspension. Then the temperature was raised to 110° C. in 1 h and the reaction mixture was stirred at this temperature for 2 h. Afterward the stirring was discontinued, the solid product was allowed to settle for 15 minutes, and the supernatant liquid was siphoned off.

Then 300 mL of fresh TiCl₄ were added to the solid product obtained as described above and the mixture was reacted under stirring at 110° C. for 1 h. Afterward the stirring was stopped, the solid product was allowed to settle for 15 minutes, and the supernatant liquid was siphoned off.

The resulted solid was washed with hexane five times at 50° C. and two more times at room temperature and finally was dried under vacuum at 40° C. to give the title catalyst.

General Procedure for the Preparation of a Phthalate Based Catalyst (Procedure B)

Into a 800 mL four-neck glass reactor, equipped with a mechanical stirrer, a reflux condenser and a thermometer and purged with nitrogen, 300 mL of TiCl₄ were introduced and cooled to 0° C. While stirring, 12.0 g of the precursor (adduct prepared as described in one of the following examples) were added. The temperature was raised to 40° C. in 0.5 h and after that diisobutyl phthalate in the amount corresponding to 0.100 moles per mole of Mg present in the precursor was added to the suspension. Then the temperature was then raised to 120° C. in 1 h and the reaction mixture was stirred at this temperature for 2 h. Afterward the stirring was discontinued, the solid product was allowed to settle for 15 minutes, and the supernatant liquid was siphoned off.

Then 300 mL of fresh TiCl₄ were added to the solid-product obtained as described above and the mixture was reacted under stirring at 120° C. for 1 h. Afterward the stirring was stopped, the solid product was allowed to settle for 15 minutes, and the supernatant liquid was siphoned off.

The solid was washed with hexane five times at 50° C. and two more times at room temperature and finally was dried under vacuum at 40° C. to give the title catalyst.

General procedure for polymerization of propylene with External Donor (Procedure I)

In a 4 L autoclave, purged with a nitrogen flow at 70° C. for 2 h, 75 mL of anhydrous hexane containing 760 mg of AlEt₃, 63.0 mg of dicyclopentyldimethoxysilane and 10.0 mg of solid catalyst prepared as described above were introduced in propylene flow at 30° C. The autoclave was closed. At the same temperature 2.0 NL of hydrogen were added and then, under stirring, 1.2 Kg of liquid propylene were fed. The temperature was raised to 70° C. in five minutes and the polymerization was carried out at this temperature for 2 h. After that, the non-reacted propylene was removed, the formed polymer was collected, dried at 70° C. under vacuum for 3 h, then weighted and analyzed for the amount of present Mg residues, based on which the activity of the catalyst was calculated.

General procedure for polymerization of propylene without External Donor (Procedure II)

In a 4 L autoclave, purged with a nitrogen flow at 70° C. for 2 h, 75 mL of anhydrous hexane containing 600 mg of AlEt₃ and 6.00 mg of solid catalyst prepared as described above were introduced in propylene flow at 30° C. The autoclave was closed. At the same temperature 1.5 NL of hydrogen were added and then, under stirring, 1.2 Kg of liquid propylene were fed. The temperature was raised to 70° C. in five minutes and the polymerization was carried out at this temperature for 2 h. After that, the non-reacted propylene was removed, the formed polymer was collected, dried at 70° C. under vacuum for 3 h, then weighted and analyzed for the amount of present Mg residues, based on which the activity of the catalyst was calculated.

### Example 1

### Preparation of the Precursor

A reaction flask fitted with a mechanical stirrer, a reflux condenser, a thermometer, and an addition funnel was charged with magnesium chips (6.14 g), tetraethoxysilane (85.0 mL) and anhydrous tetrahydrofurane (20.4 mL) in an atmosphere of dry nitrogen. Thus obtained reaction mixture was treated with 0.15 mL of a solution of iodine in iodomethane (3.0 g of iodine per 15 mL of iodomethane) at room temperature while stirring at 300 r.p.m. and then heated up to about 80° C. After decoloration of the reaction mixture it was treated dropwise during 90 min with a solution of 1-chlorobutane (31.7 mL) in anhydrous heptane (31.7 mL) keeping the temperature of the mixture in a range of 70-80° C. Upon completion of the addition the stirring was continued at 75° C. for 120 min. The formed precipitate was separated by filtration, thoroughly washed with anhydrous hexane and then dried at room temperature in vacuum to give 38.4 g of the title precursor as a white crystalline solid. The adduct composition was: Mg—15.3 wt. %, Cl—22.2 wt. %, EtO—27.8 wt. %, THF—31.2 wt. %.

The so obtained precursor was used to prepare two catalyst components (procedure A and B) that were then employed in polymerization with the procedures and results shown in table 1.

### Example 2

### Preparation of the Precursor

A reaction flask fitted with a mechanical stirrer, a reflux condenser, a thermometer, and an addition funnel was charged with magnesium chips (5.65 g), tetraethoxysilane (70.0 mL) and anhydrous tetrahydrofurane (56.0 mL) in an atmosphere of dry nitrogen. Thus obtained reaction mixture was treated with 0.15 mL of a solution of iodine in iodomethane (3.0 g of iodine per 15 mL of iodomethane) at room temperature while stirring at 300 r.p.m. and then heated up to about 80° C. After decoloration of the reaction mixture it was treated dropwise during 110 min with a solution of 1-chlorobutane (29.2 mL) in tetraethoxysilane (29.2 mL) keeping the temperature of the mixture in a range of 70-80° C. Upon completion of the addition the stirring was continued at 75° C. for 2 h. The formed precipitate was separated by filtration, thoroughly washed with anhydrous hexane and then dried at room temperature in vacuum to give the title precursor as a white crystalline solid. The adduct composition was: Mg—13.7 wt. %, Cl—19.8 wt. %, THF—42.7 wt. %.

The so obtained precursor was used to prepare two catalyst components (procedure A and B) that were then employed in polymerization with the procedures and results shown in table 1.

### Example 3

### Preparation of the Precursor

A reaction flask fitted with a mechanical stirrer, a reflux condenser, a thermometer, and an addition funnel was charged with magnesium chips (8.00 g) and tetraethoxysilane (111 mL) in an atmosphere of dry nitrogen. Thus obtained reaction mixture was treated with 0.20 mL of a solution of iodine in iodomethane (3.0 g of iodine per 15 mL of iodomethane) at room temperature while stirring at 300 r.p.m. and then heated up to about 70° C. After decoloration of the reaction mixture it was treated dropwise during 90 min with a solution of 1-chlorobutane (41.0 mL) in anhydrous heptane (41.0 mL) keeping the temperature of the mixture in a range of 70-80° C. Upon completion of the addition the stirring was continued at 75° C. for 120 min. Afterward the mixture was treated dropwise during 10 min at 60° C. with anhydrous tetrahydrofurane (26.7 mL) and, after completion of the addition, stirred at 75° C. for 120 min. The formed precipitate was separated by filtration, thoroughly washed with anhydrous hexane and then dried at room temperature in vacuum to give 47.0 g of the title precursor as a white crystalline solid. The adduct composition was: Mg—17.0 wt. %, Cl—30.8 wt. %, EtO—24.2 wt. %, THF—26.9 wt. %.

The so obtained precursor was used to prepare a catalyst component (procedure B) that was then employed in polymerization with the procedure and results shown in table 1.

### Example 4

### Preparation of the Precursor

A reaction flask fitted with a mechanical stirrer and a reflux condenser was charged with anhydrous magnesium chloride (8.58 g), magnesium ethoxide (10.3 g) and anhydrous tetrahydrofurane (246 mL) in an atmosphere of dry nitrogen. The reaction mixture was brought to a reflux and stirred at reflux temperature for 3 h. The resulted solution was then cooled to 0° C. and left at this temperature for 1 h to crystallize. After the formed crystals were filtered off, the obtained mother liquor was added fast in one portion under nitrogen to anhydrous hexane (1.23 L) kept at room temperature. A white precipitate of the adduct formed immediately. After stirring of the mixture for additional 15 min the resulted precipitate was separated by filtration, thoroughly washed with anhydrous hexane and then dried at room temperature in vacuum to give 20.9 g of the title precursor as a white crystalline solid. The adduct composition was: Mg—12.5 wt. %, Cl—18.8 wt. %, EtO—23.7 wt. %, THF—40.8 wt.

The so obtained precursor was used to prepare two catalyst components (procedure A and B) that were then employed in polymerization with the procedures and results shown in table 1.

### Example 5a

### Preparation of the Precursor

A reaction flask fitted with a mechanical stirrer and a reflux condenser was charged with anhydrous magnesium chloride (5.10 g), magnesium ethoxide (6.13 g) and anhydrous tetrahydrofurane (250 mL) in an atmosphere of dry nitrogen. The reaction mixture was brought to a reflux and stirred at reflux temperature Upon completion of the addition the obtained precipitate was separated by filtration, thoroughly washed with anhydrous hexane and then dried at room temperature in vacuum to give 17.9 g of the title precursor as a white crystalline solid. The adduct composition was: Mg—12.7 wt. %, Cl—18.9 wt. %, EtO—24.3 wt. %, THF—39.9 wt. %.

The so obtained precursor was used to prepare a catalyst component (procedure A) that was then employed in polymerization with the procedures and results shown in table 1.

### Example 5b

### Preparation of the Precursor

A reaction flask fitted with a mechanical stirrer and a reflux condenser was charged with anhydrous magnesium chloride (25.6 g), magnesium ethoxide (30.8 g) and anhydrous tetrahydrofurane (720 mL) in an atmosphere of dry nitrogen. The reaction mixture was brought to a reflux and stirred at reflux temperature for 2 h. After that, the resulted solution was cooled to room temperature and then treated at this temperature dropwise during 90 min under nitrogen with anhydrous hexane (720 mL). Upon completion of the addition the obtained precipitate was separated by filtration, thoroughly washed with anhydrous hexane and finally dried at room temperature in vacuum to give 96.5 g of the title precursor as a white crystalline solid. The adduct composition was: Mg—12.4 wt. %, Cl—18.6 wt. %, THF—40.5 wt. %.

The so obtained precursor was used to prepare a catalyst component (procedure B) that was then employed in polymerization with the procedures and results shown in table 1.

### Example 6

### Preparation of the Precursor

A reaction flask fitted with a mechanical stirrer and a reflux condenser was charged with anhydrous magnesium chloride (25.5 g), magnesium ethoxide (30.6 g) and anhydrous tetrahydrofurane (720 mL) in an atmosphere of dry nitrogen. The reaction mixture was brought to a reflux and stirred at reflux temperature for 3.5 h. After that, the resulted solution was cooled to room temperature and then treated dropwise during 120 min at this temperature with anhydrous hexane (720 mL) under nitrogen. Upon completion of the addition the obtained precipitate was separated by filtration, thoroughly washed with anhydrous hexane and finally dried at room temperature and then at 90° C. in vacuum (10 mm Hg) to furnish 69.0 g of the title precursor as a white crystalline solid. The adduct composition was: Mg—17.3 wt. %, Cl—24.5 wt. %, EtO—31.5 wt. %, THF—25.6 wt. %.

The so obtained precursor was used to prepare a catalyst component (procedure A) that was then employed in polymerization with the procedure and results shown in table 1.

### Comp. Example 7

### Preparation of the Precursor

A reaction flask fitted with a mechanical stirrer and a reflux condenser was charged with anhydrous magnesium chloride (25.5 g), magnesium ethoxide (30.6 g) and anhydrous tetrahydrofurane (720 mL) in an atmosphere of dry nitrogen. The reaction mixture was brought to a reflux and stirred at reflux temperature for 3.5 h. After that, the resulted solution was cooled to room temperature and then treated dropwise during 120 min at this temperature with anhydrous hexane (720 mL) under nitrogen. Upon completion of the addition the obtained precipitate was separated by filtration, thoroughly washed with anhydrous hexane and finally dried at room temperature and then at 90° C. in vacuum (1 mm Hg) to furnish 60.0 g of the title precursor as a white crystalline solid. The adduct composition was: Mg—19.3 wt. %, Cl—27.7 wt. %, EtO—35.3 wt. %, THF—16.6 wt. %.

The so obtained precursor was used to prepare a catalyst component (procedure A) that was then employed in polymerization with the procedure and results shown in table 1.

### Example 8

### Preparation of the Precursor

A reaction flask fitted with a mechanical stirrer and a reflux condenser was charged with anhydrous magnesium chloride (12.5 g), magnesium ethoxide (5.00 g) and anhydrous tetrahydrofurane (240 mL) in an atmosphere of dry nitrogen. The reaction mixture was brought to a reflux and stirred at reflux temperature for 3 h. After that, the resulted solution was cooled to room temperature and then added fast under nitrogen to anhydrous hexane (1.20 L) at room temperature. Upon completion of the addition the obtained precipitate was separated by filtration, thoroughly washed with anhydrous hexane and finally dried at room temperature in vacuum to give 35.3 g of the title precursor as a white crystalline solid. The adduct composition was: Mg—11.0 wt. %, Cl—24.8 wt. %, EtO—9.7 wt. %, THF—52.2 wt. %.

The so obtained precursor was used to prepare two catalyst components (procedure A and B) that were then employed in polymerization with the procedures and results shown in table 1.

### Example 9

### Preparation of the Precursor

A reaction flask fitted with a mechanical stirrer and a reflux condenser was charged with anhydrous magnesium chloride (14.2 g), magnesium ethoxide (5.80 g) and anhydrous ethyl acetate (265 mL) in an atmosphere of dry nitrogen. The reaction mixture was brought to a reflux and stirred at reflux temperature for 2 h. After that, the resulted hot solution of the adduct was added fast under nitrogen to a stirred anhydrous hexane (1.33 L) kept at room temperature (a teflon tubing with build-in filter to remove a small amount of the insoluble materials present was used for transfer of the solution). Upon completion of the addition the mixture was stirred at room temperature for 30 min. Then the obtained precipitate was separated by filtration, thoroughly washed with anhydrous hexane and finally dried at room temperature in vacuum to give 34.8 g of the title precursor as a white crystalline solid. The adduct composition was: Mg—13.4 wt. %, Cl—28.7 wt. %, ethyl acetate—41.3 wt. %.

The so obtained precursor was used to prepare two catalyst components (procedure A and B) that were then employed in polymerization with the procedures and results shown in table 1.

### Example 10

### Preparation of the Precursor

A reaction flask fitted with a mechanical stirrer and a reflux condenser was charged with anhydrous magnesium chloride (10.0 g), magnesium ethoxide (6.00 g) and anhydrous tetrahydrofurane (215 mL) in an atmosphere of dry nitrogen. The reaction mixture was brought to a reflux and stirred at reflux temperature for 3 h. The resulted solution was then cooled to room temperature and left at this temperature overnight for crystallization. The formed crystals were separated by filtration, washed with anhydrous tetrahydrofurane, then with anhydrous hexane and finally dried at room temperature in vacuum to give 25.0 g of the title precursor as a white crystalline solid. The adduct composition was: Mg—10.6 wt. %, Cl—21.4 wt. %, EtO—12.9 wt. %, THF—53.8 wt. %.

The so obtained precursor was used to prepare a catalyst component (procedure A) that was then employed in polymerization with the procedure and results shown in table 1.

### Example 11

### Preparation of the Precursor

A reaction flask fitted with a mechanical stirrer and a reflux condenser was charged with anhydrous magnesium chloride (11.6 g), magnesium ethoxide (14.0 g) and anhydrous tetrahydrofurane (320 mL) in an atmosphere of dry nitrogen. The reaction mixture was brought to a reflux and stirred at reflux temperature for 3 h. After that, the resulted solution was cooled to room temperature and then treated dropwise during 17 min at this temperature under nitrogen with a mixture of anhydrous tetraethoxysilane (150 mL) and diethyl ether (150 mL). The formed precipitate was separated by filtration, washed with anhydrous hexane and then dried at room temperature in vacuum to give 38.5 g of the title precursor as a white crystalline solid. The adduct composition was: Mg—11.5 wt. %, Cl—20.4 wt. %, EtO—17.0 wt. %, THF—47.5 wt. %.

TABLE 1

| | | | | | | | | | | | Polymerization | | | | | |
|---|---|---|---|---|---|---|---|---|---|---|---|---|---|---|---|---|
| | | | | | | | | | | | | Yield | | | | |
| | | Catalyst preparation | | | | | | | | | Polym. | Kg/g | | MFR | | |
| EX | | Prep. | Mg | Ti | LB | ID | PSD | | | | Proce- | from | XI | (MIL) | | |
| # | Precursor formula | Method | % | % | % | % | P1 | P5 | P50 | span | dure | Mg | % | g/10′ | IV | PI |
| EX. 1 | MgCl_{1.00}(OEt)_{1.00} × | B | 16.8 | 3.0 | — | 8.6 | 4.8 | 16.3 | 71.6 | 1.4 | P-I | 54.3 | 98.2 | 3.8 | 1.93 | 4.8 |
| | 0.7 THF | | | | | | | | | | | | | | | |
| | | A | 15.8 | 2.9 | 0.6 | 13.8 | 16.5 | 56.5 | 116.1 | 0.9 | P-I | 34.1 | 98.3 | 5.4 | 1.79 | 4.6 |
| EX. 2 | MgCl0.99(OEt)1.01 × | B | 18.8 | 2.4 | 0.3 | 5.5 | | | | | P-I | 72.0 | 97.9 | 3.1 | 2.10 | 4.7 |
| | 1.01 THF | | | | | | | | | | | | | | | |
| | | A | 16.1 | 3.9 | 0.6 | 14.7 | 4.6 | 8.2 | 64.6 | 1.6 | P-I | 68.2 | 98.6 | 2 | 1.72 | 3.6 |
| | | | | | | | | | | | P-II | 74.6 | 96.3 | 3.7 | 1.92 | 3.5 |
| EX. 3 | MgCl_{1.02}(OEt)_{0.98} × | B | 16.9 | 4.1 | 0.2 | 14.1 | 3.8 | 10.7 | 25.5 | 1.0 | P-I | 29.6 | 97.5 | 6.3 | 1.69 | 5.7 |
| | 0.5 THF | | | | | | | | | | | | | | | |
| EX. 4 | MgCl_{1.08}(OEt)_{0.92} × | B | 18.3 | 2.3 | — | 7.7 | 8.3 | 23.2 | 131.0 | 2.6 | P-I | 73.7 | 98.4 | 3.0 | nd | 4.0 |
| | 1.2 THF | | | | | | | | | | | | | | | |
| | | A | 14.9 | 3.3 | — | 13.5 | 9.8 | 23.2 | 116.0 | | P-I | 78.3 | 98.6 | 13.1 | nd | 3.6 |
| EX. 5a | MgCl_{1.07}(OEt)_{0.97} × | A | 14.4 | 3.4 | 0.7 | 13.5 | 3.5 | 5.4 | 30.9 | 1.2 | P-I | 50.9 | 99.3 | 4.2 | 1.81 | 3.5 |
| | 1.2 THF | | | | | | | | | | | | | | | |
| | | | | | | | | | | | P-II | 123.0 | 96.8 | Nd | 1.75 | 3.6 |
| EX. 5b | MgCl_{1.05}(OEt)_{0.95} × | B | 19.3 | 2.8 | — | 7.5 | 4.3 | 8.6 | 28.0 | 1.5 | P-I | 70.4 | 98.3 | 3.2 | 2.02 | 4.6 |
| | 1.3 THF | | | | | | | | | | | | | | | |
| EX. 6 | MgCl_{0.97}(OEt)_{1.03} × | A | 16.9 | 2.9 | 0.8 | 14.2 | 3.6 | 4.4 | 20.9 | 2.5 | P-I | 27.6 | 98.5 | 10.3 | 1.45 | 3.8 |
| | 0.49 THF | | | | | | | | | | | | | | | |
| COMP. | MgCl_{0.98}(OEt)_{1.02} × | A | 17.0 | 3.3 | 0.6 | 9.9 | 3.0 | 4.2 | 17.2 | 2.6 | P-I | 7.8 | 95.5 | 19.9 | 1.28 | 5.4 |
| EX. 7 | 0.17 THF | | | | | | | | | | | | | | | |
| EX. 8 | MgCl_{1.45}(OEt)_{0.55} × | B | 20.0 | 2.4 | — | 6.7 | 2.1 | 4.4 | 22.5 | 2.0 | P-I | 56.4 | 98.2 | 3.1 | nd | 4.2 |
| | 1.7 THF | | | | | | | | | | | | | | | |
| | | A | 16.0 | 3.0 | — | 10.2 | 3.2 | 5.8 | 24.8 | 1.9 | P-I | 62.5 | 98.5 | 4.6 | nd | 3.7 |
| | | | | | | | | | | | P-II | 95.6 | 94.8 | 13.4 | nd | 3.8 |
| EX. 9 | MgCl_{1.45}(OEt)_{0.55} × | B | 13.8 | 4.2 | — | 15.3 | — | | | | P-I | 26.2 | 98.2 | 1.7 | nd | nd |
| | 0.8 EtOAc | | | | | | | | | | | | | | | |
| | | A | 17.6 | 1.9 | 3.4 | 6.2 | | | | | P-I | 26.8 | 97.5 | 16 | 1.52 | 4.0 |
| EX. 10 | MgCl1.38(OEt)0.62 × | A | 16.2 | 3.3 | — | 11.7 | 3.9 | 6.4 | 25.6 | 1.8 | P-I | 60.0 | 98.3 | 10 | nd | 3.8 |
| | 1.7 THF | | | | | | | | | | | | | | | |
| EX. 11 | MgCl_{1.21}(OEt)_{0.79} × | B | 17.3 | 2.1 | — | 5.6 | 6 | 12 | 23 | 0.9 | P-I | 72.7 | 97.8 | 3.1 | 2.1 | 4.4 |
| | 1.3 THF¹ | | | | | | | | | | | | | | | |
| | | A | 12.5 | 3.2 | — | 10.2 | 12 | 14 | 25 | 1 | P-I | 66.5 | 98.7 | 2.5 | | 3.2 |
| | | | | | | | | | | | P-II | 112 | 96.7 | 4.6 | | 3.3 |

1-17. (canceled)

18. Lewis base adducts comprising a compound of formula MgClₙ(OR)₂₋ₙ, and an aprotic Lewis base (LB) that are in molar ratios to each other defined by formula MgClₙ(OR)₂₋ₙLBₚ in which n is from 0.1 to 1.9, p is higher than 0.4, and R is a C1-C15 hydrocarbon group.

19. The adducts according to claim 18 in which the aprotic Lewis base (LB) is at least one ester or ether.

20. The adducts according to claim 19 in which the ether is at least one cyclic ether comprising 3-5 carbon atoms.

21. The adducts according to claim 20 in which the ether is tetrahydrofurane.

22. The adducts according to claim 18 in which p is higher than 0.45.

23. The adducts according to claim 18 in which n ranges from 0.4 to 1.6.

24. A process for preparing Lewis base adducts comprising a compound of formula MgClₙ(OR)₂₋ₙ, and an aprotic Lewis base (LB) that are in molar ratios to each other defined by formula MgClₙ(OR)₂₋ₙLBₚ in which n is from 0.1 to 1.9, p is higher than 0.4, and R is a C1-C15 hydrocarbon group comprising
contacting organometallic compounds of formula ClₘMgR₂₋ₘ, where m is from 0 to 2, and R is a C1-C15 hydrocarbon group; with
an OR source where R is a C₁-C₁₅ hydrocarbon group in presence of an aprotic Lewis base (LB).

25. The process according to claim 24 in which the OR source is selected from ROH alcohols and orthosilicic acid esters where R is a C₁-C₁₅ hydrocarbon group.

26. The process according to claim 24 in which ClₘMgR₂₋ₘ is formed, and further exchange with the OR source takes place in a single step.

27. A process for preparing Lewis base adducts comprising a compound of formula MgClₙ(OR)₂₋ₙ, and an aprotic Lewis base (LB) that are in molar ratios to each other defined by formula MgClₙ(OR)₂₋ₙLBₚ in which n is from 0.1 to 1.9, p is higher than 0.4, and R is a C1-C15 hydrocarbon group comprising reacting mixtures of MgCl₂ and MgOR₂ wherein R is a C₁-C₁₅ hydrocarbon group in presence of the aprotic Lewis base (LB).

28. A catalyst component obtained by contacting at least one Lewis base adduct comprising a compound of formula MgClₙ(OR)₂₋ₙ, and an aprotic Lewis base (LB) that are in molar ratios to each other defined by formula MgClₙ(OR)₂₋ₙLBₚ in which n is from 0.1 to 1.9, p is higher than 0.4, and R is a C₁-C₁₅ hydrocarbon group with at least one compound comprising at least one transition metal belonging to one of the groups 4 to 6 of the Periodic Table of Elements (new notation).

29. The catalyst component according to claim 28 in which the compound comprising at least one transition metal is a transition metal compound selected from at least one titanium compound of formula Ti(OR″)ₙX_{y-n} in which n is between 0 and y; y is a valence of titanium; X is halogen; and R″ is an alkyl radical comprising 1-10 carbon atoms or COR″ in which R″ is a C₁-C₁₀ hydrocarbon group.

30. The catalyst component according to claim 28 further comprising at least one electron donor selected from at least one ester, ether, amine, ketone, or mixture thereof.

31. The catalyst component according to claim 30 in which the electron donor is selected from 1,3-diethers of formula (III) 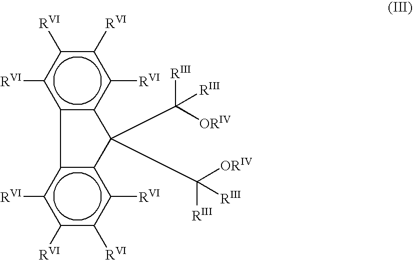
where
R^{VI} are equal or different, and are hydrogen, halogens, linear or branched C₁-C₂₀ alkyl radicals, C₃-C₂₀ cycloalkyl radicals, C₆-C₂₀ aryl radicals, C₇-C₂₀ alkylaryl radicals and C₇-C₂₀ aralkyl radicals, optionally comprising at least one heteroatom selected from the group consisting of N, O, S, P, Si and halogen as a substitute for carbon, hydrogen, or both;
R^{III} are equal or different, and are hydrogen or C₁-C₁₈ hydrocarbons
R^{IV} are equal or different, and are C₁-C₁₈ hydrocarbons.

32. The catalyst component according to claim 31 in which R^{VI} are equal or different, and are Cl, F, or combinations thereof.

33. The catalyst component according to claim 31 in which R^{VI} comprise Cl, F, or combinations thereof as the substitutes for carbon or hydrogen.

34. A catalyst system for polymerizing alpha-olefins of formula CH₂═CHR′, wherein R′ is hydrogen or a hydrocarbon radical comprising 1-12 carbon atoms, obtained by contacting a catalyst component obtained by contacting at least one Lewis base adduct comprising a compound of formula MgClₙ(OR)₂₋ₙ, and an aprotic Lewis base (LB) that are in molar ratios to each other defined by formula MgClₙ(OR)₂₂₋ₙLBₚ in which n is from 0.1 to 1.9, p is higher than 0.4, and R is a C1-C15 hydrocarbon group with at least one compound comprising at least one transition metal belonging to one of the groups 4 to 6 of the Periodic Table of Elements (new notation) with one or more organoaluminum compounds.

35. The catalyst system according to claim 34 further comprising an external electron donor compound.

36. A process for polymerizing alpha-olefins carried out in presence of a catalyst system for polymerizing alpha-olefins of formula CH₂═CHR′, wherein R′ is hydrogen or a hydrocarbon radical comprising 1-12 carbon atoms, obtained by contacting a catalyst component obtained by contacting at least one Lewis base adduct comprising a compound of formula MgClₙ(OR)₂₋ₙ, and an aprotic Lewis base (LB) that are in molar ratios to each other defined by formula MgClₙ(OR)₂₋ₙLBₚ in which n is from 0.1 to 1.9, p is higher than 0.4, and R is a C1-C15 hydrocarbon group with at least one compound comprising at least one transition metal belonging to one of the groups 4 to 6 of the Periodic Table of Elements (new notation) with one or more organoaluminum compounds.
